(19) United States
(12) Patent Application Publication
(10) Pub. No.: US 2026/0368240 A1
(43) Pub. Date: Nov. 19, 2026

(54) INFORMATION QUERY METHOD, DEVICE AND STORAGE MEDIUM

(71) Applicant: Beijing Zitiao Network Technology Co., Ltd., Beijing (CN)

(72) Inventors: Shaohua LV, Beijing (CN); Lingjie LUO, Beijing (CN); Xin ZUO, Beijing (CN); Zhihao CHEN, Beijing (CN); Junfeng SONG, Beijing (CN); Shuping WANG, Beijing (CN); Meng LI, Beijing (CN); Yijun HE, Beijing (CN); Jindong HONG, Hong Kong (CN); Shiqin QIAO, Beijing (CN)

(21) Appl. No.: 19/680,780

(22) Filed: May 18, 2026

(30) Foreign Application Priority Data
May 19, 2025 (CN) 202510646944.4

(51) Int. Cl. G06F 16/435

(52) U.S. Cl. CPC G06F 16/435

(57) ABSTRACT

Embodiments of the present disclosure provide an information query method and device, and a storage medium. The method includes: acquiring a first query request input by a user; determining, by using a first model and according to the first query request, whether the first query request corresponds to a scenario of querying rich media content; and in response to determining that the first query request corresponds to the scenario of querying rich media content, querying first media content from a plurality of pieces of media content by using a second model and according to the first query request, and generating the rich media content according to the first media content.

### CROSS-REFERENCE TO RELATED APPLICATION

This application claims the priority to and benefits of the Chinese Patent Application, No. 202510646944.4, which was filed on May 19, 2025. All the aforementioned patent applications are hereby incorporated by reference in their entireties.

### TECHNICAL FIELD

Embodiments of the present disclosure relate to an information query method and device, a storage medium, and a program product.

### BACKGROUND

In some information query or question answering interaction scenarios, some text content may be queried, but the information transfer efficiency of words is relatively low, and the cost of explaining some terms is relatively high. For example, in information query in a medical and health scenario, when a user asks how to determine a specific part when a certain part is uncomfortable, or asks to be guided to perform steps of some common therapies (such as the Heimlich maneuver), answers in text format usually cannot quickly and intuitively satisfy the needs of the user, affecting the information query experience and information acquisition efficiency of the user.

### SUMMARY

Embodiments of the present disclosure provide an information query method and device, a storage medium, and a program product.

At least one embodiment of the present disclosure provides an information query method, including:
acquiring a first query request input by a user;
determining, by using a first model and according to the first query request, whether the first query request corresponds to a scenario of querying rich media content; and
in response to determining that the first query request corresponds to the scenario of querying rich media content, querying first media content from a plurality of pieces of media content by using a second model and according to the first query request, and generating the rich media content according to the first media content.

At least one embodiment of the present disclosure provides an information query apparatus, including:
an acquisition unit configured to acquire a first query request input by a user;
a scenario recognition unit configured to determine, by using a first model and according to the first query request, whether the first query request corresponds to a scenario of querying rich media content; and
a generation unit configured to: in response to determining that the first query request corresponds to the scenario of querying rich media content, query first media content from a plurality of pieces of media content by using a second model and according to the first query request, and generate the rich media content according to the first media content.

At least one embodiment of the present disclosure provides an electronic device, including: a processor and a memory;
where the memory stores computer-executable instructions; and
the processor executes the computer-executable instructions stored in the memory to cause the at least one processor to execute the information query method according to the first aspect and various possible designs of the first aspect.

At least one embodiment of the present disclosure provides a computer-readable storage medium having, stored therein, computer-executable instructions which, when executed by a processor, implement the information query method according to the first aspect and various possible designs of the first aspect.

At least one embodiment of the present disclosure provides a computer program product including a computer program which, when executed by a processor, implements the information query method according to the first aspect and various possible designs of the first aspect.

### BRIEF DESCRIPTION OF DRAWINGS

In order to more clearly explain the technical solutions in the embodiments of the present disclosure, the drawings that need to be used in the description of the embodiments will be briefly introduced below. Obviously, the drawings in the following description are some embodiments of the present disclosure, and for those of ordinary skill in the art, other drawings may be obtained according to these drawings without paying creative efforts.

FIG. 1 is a schematic scenario diagram of an information query method provided by an embodiment of the present disclosure;

FIG. 2 is a schematic flowchart of an information query method provided by an embodiment of the present disclosure;

FIG. 3 is a schematic diagram of rich media content corresponding to a first information query request provided by an embodiment of the present disclosure;

FIG. 4 is a schematic flowchart of an information query method provided by another embodiment of the present disclosure;

FIG. 5 is a structural block diagram of an information query apparatus provided by an embodiment of the present disclosure; and

FIG. 6 is a schematic hardware structure diagram of an information query device provided by an embodiment of the present disclosure.

### DETAILED DESCRIPTION

In order to make the objectives, technical solutions, and advantages of embodiments of the present disclosure clearer, the technical solutions in the embodiments of the present disclosure will be clearly and completely described below with reference to the drawings in the embodiments of the present disclosure. Obviously, the described embodiments are some embodiments of the present disclosure, but not all the embodiments. All other embodiments obtained by those of ordinary skill in the art based on the embodiments of the present disclosure without paying any creative effort shall fall within the protection scope of the present disclosure.

In some information query or question answering interaction scenarios, some text content may be queried, but the information transfer efficiency of words is relatively low, and the cost of explaining some terms is relatively high. For example, in information query in a medical and health scenario, when a user asks how to determine a specific part when a certain part is uncomfortable, or asks to be guided to perform steps of some common therapies, answers in text format usually cannot quickly and intuitively satisfy the needs of the user, affecting the information query experience and information acquisition efficiency of the user.

In order to solve the above technical problems, embodiments of the present disclosure provide an information query method in which it is determined whether a first query request corresponds to a scenario of querying rich media content so that differentiated content query and generation may be performed, and rich media content may ultimately be returned for the first query request corresponding to the scenario of querying rich media content, so that users are provided with more intuitive and information-rich query results, and the information query experience and information acquisition efficiency of the users are improved.

An application scenario of the information query method according to an embodiment of the present disclosure is shown in FIG. 1. In this scenario, acquiring a first query request input by a user; determining, by using a first model and according to the first query request, whether the first query request corresponds to a scenario of querying rich media content; and in response to determining that the first query request corresponds to the scenario of querying rich media content, querying first media content from a plurality of pieces of media content by using a second model and according to the first query request, and generating the rich media content according to the first media content.

The information query method of the present disclosure will be described in detail below with reference to specific embodiments.

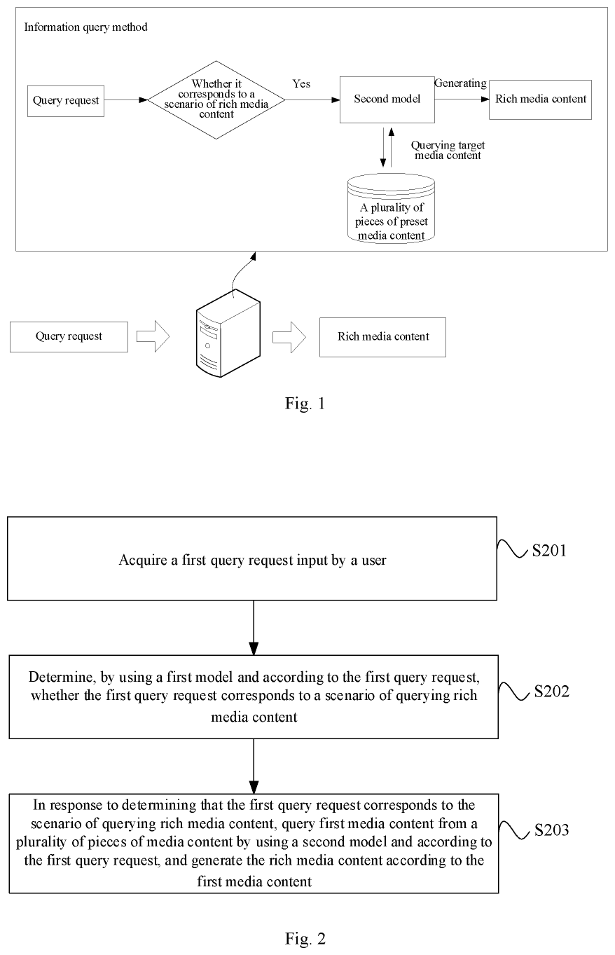

Reference is made to FIG. 2, which is a schematic flowchart of an information query method provided by an embodiment of the present disclosure. The method of this embodiment may be applied to a terminal device or a server. The information query method includes the following steps.

S201: acquiring a first query request input by a user.

In this embodiment, when the user needs to make a query, the user may input the first query request, where the first query request may be any question of the user. For example, in a medical consultation scenario, the first query request may be “vaccination schedule”, “is myopia surgery safe”, and so on. Certainly, the first query request may be different in different scenarios.

S202: determining, by using a first model and according to the first query request, whether the first query request corresponds to a scenario of querying rich media content.

In this embodiment, after the first query request is acquired, it is considered that some first query requests only need to be answered with ordinary text content. For example, for the above question “is myopia surgery safe”, it only needs to answer whether it is safe or not; while for some other first query requests, richer and more detailed answers such as videos, pictures, and charts are expected to be obtained. For example, for the above example, providing a practical operation video and/or picture may make it more convenient for users to learn and operate. For another example, for “vaccination schedule”, providing a chart may show the correspondence between a specific vaccine and time more clearly and intuitively. Therefore, in this embodiment, scenario recognition may be performed on the first query request to determine whether the first query request corresponds to a scenario of querying rich media content, where the rich media content refers to media content such as video, picture, animation, and sound, which may provide richer information. Further, rich media content may be provided as an answer for the first query request corresponding to the scenario of querying rich media content, while text content may be provided as an answer for the first query request that does not correspond to the scenario of querying rich media content, so that users are provided with efficient, differentiated, and high-quality experience.

In this embodiment, a first model may be pre-trained to determine, for a first query request, whether the first query request corresponds to a scenario of querying rich media content. The input of the first model is the first query request, and the output of the first model is a classification result of whether the first query request corresponds to the scenario of querying rich media content. Further, the type of rich media content may also be provided. The first model may be any machine learning model.

During training, a first training dataset of the first model may be acquired first.

Further, the first model may be trained according to the first training dataset. For example, for the first model, model parameters may be finely adjusted, and the model parameters may be optimized in a plurality of rounds based on evaluation results such as precision, recall, and F1. In addition, the training data in the first training dataset may be adjusted based on the model effect, for example, a historical query request and/or a rich media scenario classification may be corrected, or new training data may be added, until the evaluation results such as precision, recall, and F1 meet the requirements, then the training may be stopped. In addition, the precision and recall of the first model may also be evaluated based on real online data, or the classification result may be manually confirmed and evaluated, so as to decide whether the first model needs to be finely adjusted and optimized again, thereby ensuring the accuracy of the model.

When the first model is applied, the current first query request may be input into the first model, and the first model recognizes whether the first query request corresponds to the scenario of querying rich media content. If yes, step S203 is executed; otherwise, text content may be returned after query.

S203: in response to determining that the first query request corresponds to the scenario of querying rich media content, querying first media content from a plurality of pieces of media content by using a second model and according to the first query request, and generating the rich media content according to the first media content.

In this embodiment, a preset knowledge base may be built in advance, where the preset knowledge base may include a plurality of pieces of preset media content, where the media content includes but is not limited to media content such as video, picture, animation, sound, chart, and text.

Based on a plurality of pieces of media content in the preset knowledge base, the second model may be used to query the media content and generate the final rich media content. The second model may be any language model, and a basic framework of retrieval-augmented generation (RAG) may be applied. RAG means that when an answer needs to be generated, relevant information is first retrieved from a database or knowledge base, and then the answer is generated using the information, which may improve the understanding of the model to knowledge in a specific field and improve the accuracy of the answer. Optionally, a specific requirement of the first query request for rich media content may be determined using the first model. For example, the user may desire to query a target type of rich media content, such as video, picture, chart, animation, sound, and so on. Thus, when the second model queries the media content, the query may be made for the target type of rich media content, and the finally generated rich media content also includes the target type of rich media content.

In this embodiment, the second model may query one or more pieces of first media content from a plurality of pieces of media content based on the first query request, where the first media content may be media content with high correlation with the first query request and/or high quality, and then the final rich media content is generated according to the first media content and returned to the user.

Optionally, in order to facilitate the query made by the second model, when the preset knowledge base is built, a plurality of pieces of preset media content may be acquired, and a plurality of pieces of media content are converted into text content by using the second model, so that a text query may be made. In an optional manner, a plurality of pieces of media content are summarized separately to obtain summary content of a plurality of pieces of media content, and text query based on the summary content may quickly retrieve media content related to the content. In addition, tags may also be extracted from a plurality of pieces of media content separately and used as tags of the corresponding media content, and query based on the tags may further speed up the query. After the summary content of a plurality of pieces of media content and the tags of a plurality of pieces of media content are acquired, the summary content of a plurality of pieces of media content and the tags of a plurality of pieces of media content are vectorized separately to obtain summary content vectors and tag vectors of a plurality of pieces of media content, and a plurality of pieces of media content, the summary content vectors, and the tag vectors are stored in an association way to build the preset knowledge base, which may improve the efficiency of subsequent retrieval and save storage costs. Any known vectorization method may be used for vectorization, which is not limited here. In addition, the media content may also be parsed and segmented in advance, and then content summary and vectorization are performed to facilitate subsequent query and retrieval.

Further, when the first media content is queried from a plurality of pieces of media content using the second model, the first query request may first be vectorized using the second model to obtain a first query request vector; and then a plurality of pieces of relevant media content are acquired from a plurality of pieces of media content according to the first query request vector, for example, media content that meets a preset condition is acquired. Optionally, a preset number of pieces of media content with the highest correlation (that is, media content with top K correlation) may be acquired. The objective of acquiring a plurality of pieces of relevant media content is that considering that the quality of the media content may be different, some media content has high correlation but may be of poor quality, so it is necessary to weigh the correlation and quality to determine the final first media content.

Optionally, when a plurality of pieces of relevant media content are acquired from a plurality of pieces of media content according to the first query request vector, the first query request vector may be matched with tag vectors of a plurality of pieces of media content respectively using the second model to determine a plurality of pieces of candidate media content; and the first query request vector is matched with summary content vectors of a plurality of pieces of candidate media content to determine a plurality of pieces of relevant media content. First, the first query request vector is matched with the tag vectors, which may effectively reduce the retrieval cost and reduce the number of subsequent matches between the first query request vector and the summary content vectors, thereby improving the query efficiency.

Certainly, in the above process, it is also possible to acquire only the summary content or tags of a plurality of pieces of media content and the corresponding summary content vectors or tag vectors. Accordingly, the query is made based only on the summary content vectors or tag vectors during the query. Alternatively, other methods may be used to query relevant media content from a plurality of pieces of media content, which may be not limited in this embodiment.

After a plurality of pieces of relevant media content are acquired, quality evaluation may be performed on a plurality of pieces of relevant media content, so as to determine the final first media content by weighing the correlation and quality.

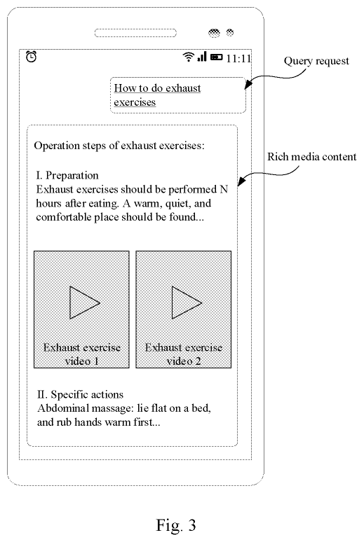

Further, the rich media content may be generated according to the first media content. Optionally, the first media content may be summarized using the second model to obtain summary text, and the summary text is merged with the first media content to generate the rich media content. For example, as shown in FIG. 3, assuming that the first query request is “how to do exhaust exercises”, after the first media content related to “exhaust exercises” is acquired, the second model may be used to summarize the content of the first media content to obtain operation step text content of “exhaust exercises”, and the operation step text content of “exhaust exercises” is combined with the first media content related to “exhaust exercises” to obtain rich media content, which is displayed to the user.

Certainly, any other feasible manner may be used to generate the rich media content according to the first media content, which may be not limited in this embodiment.

According to the information query method provided in this embodiment, a first query request input by a user is acquired; then, it is determined, by using a first model and according to the first query request, whether the first query request corresponds to a scenario of querying rich media content; and in response to determining that the first query request corresponds to the scenario of querying rich media content, first media content is queried from a plurality of pieces of media content by using a second model and according to the first query request, and rich media content is generated according to the first media content. In this embodiment, by determining whether the first query request corresponds to the scenario of querying rich media content, differentiated content query and generation may be performed, and rich media content may ultimately be returned for the first query request corresponding to the scenario of querying rich media content, so that users are provided with more intuitive and information-rich query results, and the information query experience and information acquisition efficiency of the users are improved.

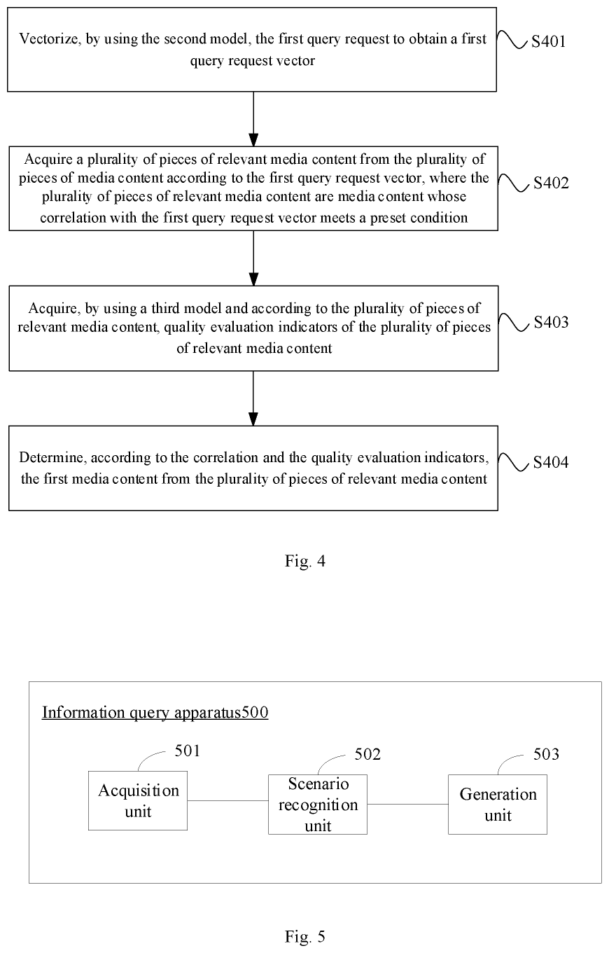

On the basis of any of the above embodiments, as shown in FIG. 4, when the first media content is queried from a plurality of pieces of media content by using the second model and according to the first query request, the method may specifically include the following steps.

S401: vectorizing, by using the second model, the first query request to obtain a first query request vector.

S402: acquiring a plurality of pieces of relevant media content from the plurality of pieces of media content according to the first query request vector, where the plurality of pieces of relevant media content are media content whose correlation with the first query request vector meets a preset condition.

S403: acquiring, by using a third model and according to the plurality of pieces of relevant media content, quality evaluation indicators of the plurality of pieces of relevant media content.

S404: determining, according to the correlation and the quality evaluation indicators, the first media content from the plurality of pieces of relevant media content.

In this embodiment, the first query request vector corresponding to the first query request may be acquired by using the second model, and the relevant media content is acquired from the plurality of pieces of media content according to the first query request vector. Considering that the quality of the relevant media content may be different, a plurality of pieces of relevant media content may be acquired, and then the media content with higher quality may be selected as the first media content. In order to perform quality evaluation on the media content, in this embodiment, a third model may be pre-trained to perform quality evaluation on the input media content to obtain a quality evaluation indicator value, where any feasible machine learning model may be used for the third model.

During training of the third model, the third model may be trained according to a second training dataset to finally obtain the third model. The sample media content may be embedded in advance and input into the third model as training data.

When the third model is applied, a plurality of pieces of relevant media content may be separately input into the third model. Optionally, the relevant media content may be encoded and then input into the third model, and the corresponding quality evaluation indicators are output. Further, the first media content may be determined from a plurality of pieces of relevant media content according to the correlation and the quality evaluation indicators. For example, the correlation and the quality evaluation indicators may be weighted and summed to obtain a comprehensive indicator, and one or more pieces of relevant media content with the highest comprehensive indicator are selected as the first media content. Alternatively, the relevant media content may be sorted according to the level of the quality evaluation indicators, and one or more pieces of relevant media content with the highest quality evaluation indicators are selected from the relevant media content as the first media content. Alternatively, other methods may be used to determine the first media content from a plurality of pieces of relevant media content according to the correlation and the quality evaluation indicators.

On the basis of any of the above embodiments, when querying the first media content from the plurality of pieces of media content by using the second model and according to the first query request, the method may include:
adjusting, by using the second model, the first query request to obtain a second query request, and querying the first media content from the plurality of pieces of media content according to the second query request.

In this embodiment, considering that the first query request input by the user may be relatively broad and not specific enough, the first query request may be adjusted by using the second model. For example, the first query request is expanded and supplemented with more details to improve the pertinence and effectiveness of the first query request. For example, the first query request input by the user is “what to do if I have a cold”, and the second query request “what are the treatment methods for different symptoms of a cold, how to relieve the symptoms of a cold, and precautions for life and diet” may be obtained by expanding and supplementing with more details using the second model, so that more accurate and rich first media content may be acquired during query to meet the actual needs of the user.

On the basis of any of the above embodiments, the above information query method may be applied to a medical and health-related consultation or question answering scenario. When the first query request input by the user is acquired, a medical-related first query request input by the user is acquired; a preset knowledge base is a medical knowledge base, where the medical knowledge base includes a plurality of medical-related pieces of media content. Further, when the first media content is queried from a plurality of pieces of media content by using the second model and according to the first query request, and the rich media content is generated according to the first media content, the first media content is queried from a plurality of medical-related pieces of media content by using the second model and according to the first query request, and the rich media content is generated according to the first media content, so that the answer is more accurate and reliable, and the query experience of the user is improved.

Corresponding to the information query method of the above embodiments, FIG. 5 is a structural block diagram of an information query apparatus provided by an embodiment of the present disclosure. For ease of description, only parts related to the embodiments of the present disclosure are shown. Referring to FIG. 5, the information query apparatus 500 includes: an acquisition unit 501, a scenario recognition unit 502, and a generation unit 503.

The acquisition unit 501 is configured to acquire a first query request input by a user.

The scenario recognition unit 502 is configured to determine, by using a first model and according to the first query request, whether the first query request corresponds to a scenario of querying rich media content.

The generation unit 503 is configured to: in response to determining that the first query request corresponds to the scenario of querying rich media content, query first media content from a plurality of pieces of media content by using a second model and according to the first query request, and generate the rich media content according to the first media content.

In one or more embodiments of the present disclosure, when the generation unit 503 queries the first media content from the plurality of pieces of media content by using the second model and according to the first query request, the generation unit 503 is configured to:
vectorize, by using the second model, the first query request to obtain a first query request vector;
acquire a plurality of pieces of relevant media content from the plurality of pieces of media content according to the first query request vector, wherein the plurality of pieces of relevant media content are media content whose correlation with the first query request vector meets a preset condition;
acquire, by using a third model and according to the plurality of pieces of relevant media content, quality evaluation indicators of the plurality of pieces of relevant media content; and
determine, according to the correlation and the quality evaluation indicators, the first media content from the plurality of pieces of relevant media content.

In one or more embodiments of the present disclosure, when the generation unit 503 acquires the plurality of pieces of relevant media content from the plurality of pieces of media content according to the first query request vector, the generation unit 503 is configured to:
match, by using the second model, the first query request vector with tag vectors of the plurality of pieces of media content respectively to determine a plurality of pieces of candidate media content; and
match the first query request vector with summary content vectors of the plurality of pieces of candidate media content to determine the plurality of pieces of relevant media content.

In one or more embodiments of the present disclosure, when generating the rich media content according to the first media content, the generation unit 503 is configured to:
summarize, by using the second model, the first media content to obtain summary text, and merge the summary text with the first media content to generate the rich media content.

In one or more embodiments of the present disclosure, when the generation unit 503 queries the first media content from the plurality of pieces of media content by using the second model and according to the first query request, the generation unit 503 is configured to:
adjust, by using the second model, the first query request to obtain a second query request, and query the first media content from the plurality of pieces of media content according to the second query request.

In one or more embodiments of the present disclosure, before acquiring the plurality of pieces of relevant media content from the plurality of pieces of media content according to the first query request vector, the generation unit 503 is further configured to:
acquire the plurality of pieces of media content, summarize the plurality of pieces of media content separately by using the second model to obtain summary content of the plurality of pieces of media content, and extract tags from the plurality of pieces of media content separately to use as tags of plurality of pieces of media content;
vectorize the summary content of the plurality of pieces of media content and the tags of the plurality of pieces of media content separately to obtain summary content vectors and tag vectors of the plurality of pieces of media content; and
store the plurality of pieces of media content, the summary content vectors, and the tag vectors in an association way.

In one or more embodiments of the present disclosure, when acquiring the first query request input by the user, the acquisition unit is configured to:
acquire a medical-related first query request input by the user; and
when the generation unit 503 queries the first media content from the plurality of pieces of media content by using the second model and according to the first query request, and generates the rich media content according to the first media content, the generation unit 503 is configured to:
query, by using the second model and according to the first query request, first media content from a plurality of medical-related pieces of media content, and generate the rich media content according to the first media content.

The device provided by this embodiment may be used to implement the technical solutions of the above method embodiments, and the implementation principles and technical effects thereof are similar, which will not be repeated here in this embodiment.

In order to implement the above embodiments, an embodiment of the present disclosure further provides an electronic device.

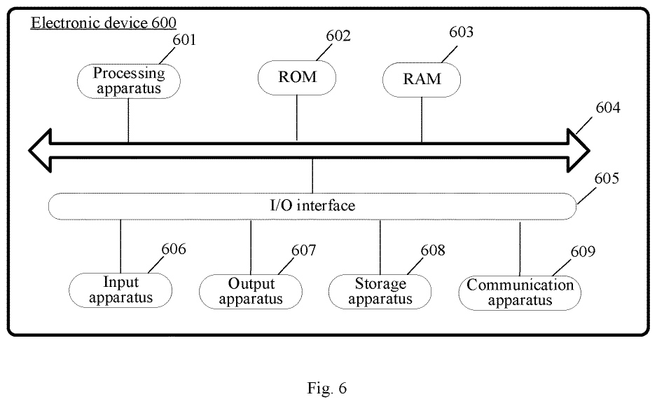

Reference is made to FIG. 6, which shows a schematic structural diagram of an electronic device 600 suitable for implementing an embodiment of the present disclosure. The electronic device 600 may be a terminal device or a server. The terminal device may include, but is not limited to, mobile terminals such as a mobile phone, a laptop, a digital broadcast receiver, a personal digital assistant (abbreviated as PDA), a tablet computer, a portable media player (abbreviated as PMP), and a vehicle-mounted terminal (such as vehicle-mounted navigation terminal), and fixed terminals such as a digital TV and a desktop computer. The electronic device shown in FIG. 6 is only an example, and should not impose any limitation on the function and scope of use of the embodiments of the present disclosure.

As shown in FIG. 6, the electronic device 600 may include a processing apparatus (such as a central processing unit and a graphics processor) 601 that may perform various appropriate actions and processing according to a program stored in a read-only memory (abbreviated as ROM) 602 or a program loaded from a storage apparatus 608 into a random-access memory (abbreviated as RAM) 603. The RAM 603 further stores various programs and data required for operations of the electronic device 600. The processing apparatus 601, the ROM 602, and the RAM 603 are connected to each other through a bus 604. An input/output (I/O) interface 605 is also connected to the bus 604.

Usually, the following apparatus may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (abbreviated as LCD), a speaker, and a vibrator; the storage apparatus 608 including, for example, a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or provide all the apparatuses shown. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product including a computer program carried on a computer-readable medium, where the computer program contains program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiment of the present disclosure are executed.

It should be noted that the above-mentioned computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium that contains or stores a program, and the program may be used by or in combination with an instruction execution system, apparatus, or device. In the present disclosure, a computer-readable signal medium may include a data signal propagated on a baseband or as a part of a carrier wave, and computer-readable program code is carried in the data signal. This propagated data signal may be in a plurality of forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted in any suitable medium, including but not limited to: wire, optical cable, RF (radio frequency), etc., or any suitable combination of the above.

The above-mentioned computer-readable medium may be contained in the above-mentioned electronic device, or may exist alone without being assembled into the electronic device.

The above-mentioned computer-readable medium carries one or more programs which, when executed by the electronic device, cause the electronic device to perform the method shown in the above-mentioned embodiments.

The computer program code for performing the operations of the present disclosure may be written in one or more programming languages or a combination thereof, where the programming languages include object-oriented programming languages such as Java, Smalltalk, and C++, and conventional procedural programming languages such as “C” language or similar programming languages. The program code may be executed entirely on a user computer, partly on the user computer, as a stand-alone software package, partly on the user computer and partly on a remote computer, or entirely on the remote computer or server. In the case of involving the remote computer, the remote computer may be connected to the user computer through any kind of network, including a local area network (abbreviated as LAN) or a wide area network (abbreviated as WAN), or it may be connected to an external computer (for example, connected through the Internet using an Internet service provider).

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in a software manner or in a hardware manner. The name of the unit does not constitute a limitation on the unit itself under certain circumstances. For example, the first acquisition unit may also be described as “a unit for acquiring at least two internet protocol addresses”.

The functions described above herein may be performed at least partly by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), and so on.

In a first aspect, according to one or more embodiments of the present disclosure, an information query method is provided, including:
acquiring a first query request input by a user;
determining, by using a first model and according to the first query request, whether the first query request corresponds to a scenario of querying rich media content; and
in response to determining that the first query request corresponds to the scenario of querying rich media content, querying first media content from a plurality of pieces of media content by using a second model and according to the first query request, and generating the rich media content according to the first media content.

According to one or more embodiments of the present disclosure, the querying first media content from a plurality of pieces of media content by using a second model and according to the first query request includes:
vectorizing, by using the second model, the first query request to obtain a first query request vector;
acquiring a plurality of pieces of relevant media content from the plurality of pieces of media content according to the first query request vector, wherein the plurality of pieces of relevant media content are media content whose correlation with the first query request vector meets a preset condition;
acquiring, by using a third model and according to the plurality of pieces of relevant media content, quality evaluation indicators of the plurality of pieces of relevant media content; and
determining, according to the correlation and the quality evaluation indicators, the first media content from the plurality of pieces of relevant media content.

According to one or more embodiments of the present disclosure, the acquiring a plurality of pieces of relevant media content from the plurality of pieces of media content according to the first query request vector includes:
matching, by using the second model, the first query request vector with tag vectors of the plurality of pieces of media content respectively to determine a plurality of pieces of candidate media content; and
matching the first query request vector with summary content vectors of the plurality of pieces of candidate media content to determine the plurality of pieces of relevant media content.

According to one or more embodiments of the present disclosure, the generating the rich media content according to the first media content includes:
summarizing, by using the second model, the first media content to obtain summary text, and merging the summary text with the first media content to generate the rich media content.

According to one or more embodiments of the present disclosure, the querying first media content from a plurality of pieces of media content by using a second model and according to the first query request includes:
adjusting, by using the second model, the first query request to obtain a second query request, and querying the first media content from the plurality of pieces of media content according to the second query request.

According to one or more embodiments of the present disclosure, before the acquiring a plurality of pieces of relevant media content from the plurality of pieces of media content according to the first query request vector, the method further includes:
acquiring the plurality of pieces of media content, summarizing the plurality of pieces of media content separately by using the second model to obtain summary content of the plurality of pieces of media content, and extracting tags from the plurality of pieces of media content separately to use as tags of the plurality of pieces of media content;
vectorizing the summary content of the plurality of pieces of media content and the tags of the plurality of pieces of media content separately to obtain summary content vectors and tag vectors of the plurality of pieces of media content; and
storing the plurality of pieces of media content, the summary content vectors, and the tag vectors in an association way.

According to one or more embodiments of the present disclosure, the acquiring a first query request input by a user includes:
acquiring a medical-related first query request input by the user; and
where the querying first media content from a plurality of pieces of media content by using a second model and according to the first query request, and generating the rich media content according to the first media content includes:
querying, by using the second model and according to the first query request, first media content from a plurality of medical-related pieces of media content, and generating the rich media content according to the first media content.

In a second aspect, according to one or more embodiments of the present disclosure, an information query apparatus is provided, including:
an acquisition unit, which is configured to acquire a first query request input by a user;
a scenario recognition unit, which is configured to determine, by using a first model and according to the first query request, whether the first query request corresponds to a scenario of querying rich media content; and
a generation unit, which is configured to: in response to determining that the first query request corresponds to the scenario of querying rich media content, query first media content from a plurality of pieces of media content by using a second model and according to the first query request, and generate the rich media content according to the first media content.

In one or more embodiments of the present disclosure, when the generation unit queries the first media content from the plurality of pieces of media content by using the second model and according to the first query request, the generation unit is configured to:
vectorize, by using the second model, the first query request to obtain a first query request vector;
acquire a plurality of pieces of relevant media content from the plurality of pieces of media content according to the first query request vector, wherein the plurality of pieces of relevant media content are media content whose correlation with the first query request vector meets a preset condition;
acquire, by using a third model and according to the plurality of pieces of relevant media content, quality evaluation indicators of the plurality of pieces of relevant media content; and
determine, according to the correlation and the quality evaluation indicators, the first media content from the plurality of pieces of relevant media content.

In one or more embodiments of the present disclosure, when the generation unit acquires the plurality of pieces of relevant media content from the plurality of pieces of media content according to the first query request vector, the generation unit is configured to:
match, by using the second model, the first query request vector with tag vectors of the plurality of pieces of media content respectively to determine a plurality of pieces of candidate media content; and
match the first query request vector with summary content vectors of the plurality of pieces of candidate media content to determine the plurality of pieces of relevant media content.

In one or more embodiments of the present disclosure, when generating the rich media content according to the first media content, the generation unit is configured to:
summarize, by using the second model, the first media content to obtain summary text, and merge the summary text with the first media content to generate the rich media content.

In one or more embodiments of the present disclosure, when the generation unit queries the first media content from the plurality of pieces of media content by using the second model and according to the first query request, the generation unit is configured to:
adjust, by using the second model, the first query request to obtain a second query request, and
query the first media content from the plurality of pieces of media content according to the second query request.

In one or more embodiments of the present disclosure, before acquiring the plurality of pieces of relevant media content from the plurality of pieces of media content according to the first query request vector, the generation unit is further configured to:
acquire the plurality of pieces of media content, summarize the plurality of pieces of media content separately by using the second model to obtain summary content of the plurality of pieces of media content, and extract tags from the plurality of pieces of media content separately to use as tags of the plurality of pieces of media content;
vectorize the summary content of the plurality of pieces of media content and the tags of a plurality of pieces of media content separately to obtain summary content vectors and tag vectors of a plurality of pieces of media content; and
store the plurality of pieces of media content, the summary content vectors, and the tag vectors in an association way.

In one or more embodiments of the present disclosure, when acquiring the first query request input by the user, the acquisition unit is configured to:
acquire a medical-related first query request input by the user; and
when the generation unit queries the first media content from the plurality of pieces of media content by using the second model and according to the first query request, and generates the rich media content according to the first media content, the generation unit is configured to:
query, by using the second model and according to the first query request, first media content from a plurality of medical-related pieces of media content, and generate the rich media content according to the first media content.

In a third aspect, according to one or more embodiments of the present disclosure, an electronic device is provided, including: at least one processor and a memory;
where the memory stores computer-executable instructions; and
the at least one processor executes the computer-executable instructions stored in the memory to cause the at least one processor to execute the information query method according to the first aspect and various possible designs of the first aspect.

In a fourth aspect, according to one or more embodiments of the present disclosure, a computer-readable storage medium is provided having, stored therein, computer-executable instructions which, when executed by a processor, implement the information query method according to the first aspect and various possible designs of the first aspect.

In a fifth aspect, according to one or more embodiments of the present disclosure, a computer program product is provided including a computer program which, when executed by a processor, implements the information query method according to the first aspect and various possible designs of the first aspect.

The above description is merely illustration of preferred embodiments of the present disclosure and applied technical principles. Those skilled in the art should understand that the scope of disclosure involved in the present disclosure is not limited to the technical solutions formed by specific combinations of the above technical features, and should also cover other technical solutions formed by any combination of the above technical features or equivalent features thereof without departing from the above concept of disclosure. For example, the above features and the technical features provided in the present disclosure (but not limited to) with similar functions may be replaced each other to form a technical solution.

In addition, although the operations are depicted in a particular order, this should not be understood as requiring the operations to be performed in the particular order shown or in a sequential order. Under certain circumstances, multitasking and parallel processing may be advantageous. Likewise, although the above discussion contains a number of specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Conversely, the specific features and actions described above are merely exemplary forms of implementing the claims.

1. An information query method, comprising:
acquiring a first query request input by a user;
determining, by using a first model and according to the first query request, whether the first query request corresponds to a scenario of querying rich media content; and
in response to determining that the first query request corresponds to the scenario of querying rich media content, querying first media content from a plurality of pieces of media content by using a second model and according to the first query request, and generating the rich media content according to the first media content.

2. The method of claim 1, wherein the querying first media content from a plurality of pieces of media content by using a second model and according to the first query request comprises:
vectorizing, by using the second model, the first query request to obtain a first query request vector;
acquiring a plurality of pieces of relevant media content from the plurality of pieces of media content according to the first query request vector, wherein the plurality of pieces of relevant media content are media content whose correlation with the first query request vector meets a preset condition;
acquiring, by using a third model and according to the plurality of pieces of relevant media content, quality evaluation indicators of the plurality of pieces of relevant media content; and
determining, according to the correlation and the quality evaluation indicators, the first media content from the plurality of pieces of relevant media content.

3. The method of claim 2, wherein the acquiring a plurality of pieces of relevant media content from the plurality of pieces of media content according to the first query request vector comprises:
matching, by using the second model, the first query request vector with tag vectors of the plurality of pieces of media content respectively to determine a plurality of pieces of candidate media content; and
matching the first query request vector with summary content vectors of the plurality of pieces of candidate media content to determine the plurality of pieces of relevant media content.

4. The method of claim 1, wherein the generating the rich media content according to the first media content comprises:
summarizing, by using the second model, the first media content to obtain summary text, and merging the summary text with the first media content to generate the rich media content.

5. The method of claim 1, wherein the querying first media content from a plurality of pieces of media content by using a second model and according to the first query request comprises:
adjusting, by using the second model, the first query request to obtain a second query request, and querying the first media content from the plurality of pieces of media content according to the second query request.

6. The method of claim 3, wherein before the acquiring a plurality of pieces of relevant media content from the plurality of pieces of media content according to the first query request vector, the method further comprises:
acquiring the plurality of pieces of media content, summarizing the plurality of pieces of media content separately by using the second model to obtain summary content of the plurality of pieces of media content, and extracting tags from the plurality of pieces of media content separately to use as tags of the plurality of pieces of media content;
vectorizing the summary content of the plurality of pieces of media content and the tags of the plurality of pieces of media content separately to obtain summary content vectors and tag vectors of the plurality of pieces of media content; and
storing the plurality of pieces of media content, the summary content vectors, and the tag vectors in an association way.

7. The method of claim 1, wherein the acquiring a first query request input by a user comprises:
acquiring a medical-related first query request input by the user; and
wherein the querying first media content from a plurality of pieces of media content by using a second model and according to the first query request, and generating the rich media content according to the first media content comprises:
querying, by using the second model and according to the medical-related first query request, first media content from a plurality of medical-related pieces of media content, and generating the rich media content according to the first media content.

8. An electronic device, comprising: at least one processor and at least one memory;
wherein the at least one memory stores computer-executable instructions; and
the at least one processor executes the computer-executable instructions stored in the at least one memory to cause the at least one processor to execute an information query method, wherein the method comprises:
acquiring a first query request input by a user;
determining, by using a first model and according to the first query request, whether the first query request corresponds to a scenario of querying rich media content; and
in response to determining that the first query request corresponds to the scenario of querying rich media content, querying first media content from a plurality of pieces of media content by using a second model and according to the first query request, and generating the rich media content according to the first media content.

9. The electronic device of claim 8, wherein the querying first media content from a plurality of pieces of media content by using a second model and according to the first query request comprises:
vectorizing, by using the second model, the first query request to obtain a first query request vector;
acquiring a plurality of pieces of relevant media content from the plurality of pieces of media content according to the first query request vector, wherein the plurality of pieces of relevant media content are media content whose correlation with the first query request vector meets a preset condition;
acquiring, by using a third model and according to the plurality of pieces of relevant media content, quality evaluation indicators of the plurality of pieces of relevant media content; and
determining, according to the correlation and the quality evaluation indicators, the first media content from the plurality of pieces of relevant media content.

10. The electronic device of claim 9, wherein the acquiring a plurality of pieces of relevant media content from the plurality of pieces of media content according to the first query request vector comprises:
matching, by using the second model, the first query request vector with tag vectors of the plurality of pieces of media content respectively to determine a plurality of pieces of candidate media content; and
matching the first query request vector with summary content vectors of the plurality of pieces of candidate media content to determine the plurality of pieces of relevant media content.

11. The electronic device of claim 8, wherein the generating the rich media content according to the first media content comprises:
summarizing, by using the second model, the first media content to obtain summary text, and merging the summary text with the first media content to generate the rich media content.

12. The electronic device of claim 8, wherein the querying first media content from a plurality of pieces of media content by using a second model and according to the first query request comprises:
adjusting, by using the second model, the first query request to obtain a second query request, and querying the first media content from the plurality of pieces of media content according to the second query request.

13. The electronic device of claim 10, wherein before the acquiring a plurality of pieces of relevant media content from the plurality of pieces of media content according to the first query request vector, the method further comprises:
acquiring the plurality of pieces of media content, summarizing the plurality of pieces of media content separately by using the second model to obtain summary content of the plurality of pieces of media content, and extracting tags from the plurality of pieces of media content separately to use as tags of the plurality of pieces of media content;
vectorizing the summary content of the plurality of pieces of media content and the tags of the plurality of pieces of media content separately to obtain summary content vectors and tag vectors of the plurality of pieces of media content; and
storing the plurality of pieces of media content, the summary content vectors, and the tag vectors in an association way.

14. The electronic device of claim 8, wherein the acquiring a first query request input by a user comprises:
acquiring a medical-related first query request input by the user; and
wherein the querying first media content from a plurality of pieces of media content by using a second model and according to the first query request, and generating the rich media content according to the first media content comprises:
querying, by using the second model and according to the medical-related first query request, first media content from a plurality of medical-related pieces of media content, and generating the rich media content according to the first media content.

15. A non-transitory computer-readable storage medium having, stored therein, computer-executable instructions which, when executed by a processor, implement an information query method, wherein the method comprises:
acquiring a first query request input by a user;
determining, by using a first model and according to the first query request, whether the first query request corresponds to a scenario of querying rich media content; and
in response to determining that the first query request corresponds to the scenario of querying rich media content, querying first media content from a plurality of pieces of media content by using a second model and according to the first query request, and generating the rich media content according to the first media content.

16. The non-transitory computer-readable storage medium of claim 15, wherein the querying first media content from a plurality of pieces of media content by using a second model and according to the first query request comprises:
vectorizing, by using the second model, the first query request to obtain a first query request vector;
acquiring a plurality of pieces of relevant media content from the plurality of pieces of media content according to the first query request vector, wherein the plurality of pieces of relevant media content are media content whose correlation with the first query request vector meets a preset condition;
acquiring, by using a third model and according to the plurality of pieces of relevant media content, quality evaluation indicators of the plurality of pieces of relevant media content; and
determining, according to the correlation and the quality evaluation indicators, the first media content from the plurality of pieces of relevant media content.

17. The non-transitory computer-readable storage medium of claim 16, wherein the acquiring a plurality of pieces of relevant media content from the plurality of pieces of media content according to the first query request vector comprises:
matching, by using the second model, the first query request vector with tag vectors of the plurality of pieces of media content respectively to determine a plurality of pieces of candidate media content; and
matching the first query request vector with summary content vectors of the plurality of pieces of candidate media content to determine the plurality of pieces of relevant media content.

18. The non-transitory computer-readable storage medium of claim 15, wherein the generating the rich media content according to the first media content comprises:
summarizing, by using the second model, the first media content to obtain summary text, and merging the summary text with the first media content to generate the rich media content.

19. The non-transitory computer-readable storage medium of claim 15, wherein the querying first media content from a plurality of pieces of media content by using a second model and according to the first query request comprises:
adjusting, by using the second model, the first query request to obtain a second query request, and querying the first media content from the plurality of pieces of media content according to the second query request.

20. The non-transitory computer-readable storage medium of claim 17, wherein before the acquiring a plurality of pieces of relevant media content from the plurality of pieces of media content according to the first query request vector, the method further comprises:
acquiring the plurality of pieces of media content, summarizing the plurality of pieces of media content separately by using the second model to obtain summary content of the plurality of pieces of media content, and extracting tags from the plurality of pieces of media content separately to use as tags of the plurality of pieces of media content;
vectorizing the summary content of the plurality of pieces of media content and the tags of the plurality of pieces of media content separately to obtain summary content vectors and tag vectors of the plurality of pieces of media content; and
storing the plurality of pieces of media content, the summary content vectors, and the tag vectors in an association way.
